(19) United States
(12) Patent Application Publication
(10) Pub. No.: US 2008/0303980 A1
(43) Pub. Date: Dec. 11, 2008

(54) Optical Film with Surface Structure

(76) Inventors: Whey-Bin LOR, Fongyuan City (TW); Hao-Jan KUO, Taipei City (TW); Kuang-Lin Yuan, Taichung City (TW)

Correspondence Address: BRUCE H. TROXELL, SUITE 1404, 5205 LEESBURG PIKE, FALLS CHURCH, VA, 22041, US

(21) Appl. No.: 12/133,422

(22) Filed: Jun. 5, 2008

(30) Foreign Application Priority Data
Jun. 6, 2007 (TW) 096120390

(51) Int. Cl. G02F 1/13357

(52) U.S. Cl. 349/65

(57) ABSTRACT

An optical film with a surface structure includes one surface of a substrate comprising a plurality of light control elements with their longitudinal axes arranged approximately parallel to each other, in which each element includes an independent peak formed by two inclined faces and the two inclined faces between each two independent peaks are connected to each other to form an independent valley; heights of the independent peaks are periodically varied; a virtual connecting line of summits of the independent peaks varied from high to low or from low to high is a straight line, a spacing interval between the independent valleys is varied in a geometric ratio with the height of the independent peak.

### BACKGROUND OF THE INVENTION

1. Field of the Invention

The present invention relates to an optical film, and more particularly to an optical film with a plurality of prism rod structures required for a backlight system of a liquid crystal display or other electronic devices.

2. Description of Related Art

Please refer to FIG. 1. A backlight system of a general liquid crystal display (LCD) comprises a cold cathode fluorescence lamp (CCFL) 11, light guiding plate (LGP) 12, bottom diffuser 13, prism sheet 14, top diffuser 15 and reflector 16.

Please refer to FIG. 2. A conventional prism sheet 14 is constituted by a plurality of triangular prism rods 141 with their longitudinal axes parallel to each other and a substrate 142. The prism rods 141 are coupled to one side of the substrate 142. A height and a width of each prism rod 141 are the same, and the height of a peak of the prism rod 141 is not varied, a course of the peak is a straight line, two inclined faces at two sides of the peak are symmetrical. The conventional prism sheet 14 is provided with a surface structure constituted by a plurality of regular prism rods 141.

Please refer to FIG. 3. There are three optical path modes of the prism sheet 14:

1. total reflection (TRI) recycle:

When a light beam 143 is projected from an inside of a prism approximately within ±4.degree. relative to a virtual perpendicular axis perpendicular to a bottom face of the prism rod 141, it is influenced by total reflection phenomena of inclined faces of the prism rod 141, recycled toward a back light source after two total reflections and diffused, propagated and utilized continuously;

2. second reflection recycle:

After a light beam 144 is refracted by two prism rods 141, it is then recycled to the back light source and diffused, propagated and utilized continuously;

3. directed reflective:

A beam 145 is refracted out through an inclined face of the prism rod 141, this optical path mode have light gathering function; only light beams refracted out within the range of a vision angle 80.degree. of the prism rod 141 can be utilized, as shown in FIG. 3.

Please refer to FIG. 4. The prism sheet 14 with the plurality of regularly arranged triangular prism rods 141 with their longitudinal axes parallel to each other will yield the following problems when a upper side thereof is stacked with a upper layer material film such as a upper diffuser 15 or another prism sheet:
1. adhesion will happen between the prism sheet 14 and the upper diffuser 15 above it.
2. an adhesion area 151 of the prism sheet 14 and the upper diffuser 15 has white spots thereon while being observed at a large angle of view.
3. peaks of the prism sheet 14 at the adhesion area 151 directly brought into contact with the upper layer material film such as the upper diffuser 15 and scratches the upper layer material film easily.

For improving a good deal problems caused when a lower layer of light directing film and a upper layer material are stacked together, U.S. Pat. No. 5,771,328 discloses a light directing film including a first surface and a second structured surface. The structured surface includes a repeating pattern of prism zones including at least a first zone having a plurality of prism elements with peaks disposed at a first distance from a reference plane and a second zone having a plurality of prism elements with peaks disposed less than the first distance from a reference plane. The width of the first zone preferably measures less than about 300 microns.

In the light directing film disclosed by the US patent mentioned above, the plurality of higher peaks of the first zone is used to support a upper layer material at a lower surface thereof and not all peaks of the light directing film are used to support the upper layer material at the lower surface thereof such that it can alleviate adhesion caused from the mutual stacking of the light directing film and the upper layer material and reduce the white spots and scratches generated while being observed at a large angle of view.

### SUMMARY OF THE INVENTION

For allowing an optical film to have an innovative supporting structure, alleviating adhesion caused when a prism sheet supports a upper layer material at a lower surface thereof and reducing white spots and scratches generated while being observed at a large angle of view, the present invention is proposed.

The main object of the present invention is to provide an optical film with a surface structure, capable of alleviating adhesion generated from a contact with a upper layer material film.

Another object of the present invention is to provide an optical film with a surface structure, capable of reducing an adhesion area of a prism sheet and a upper layer material and white spots generated while being observed at a large angle of view.

Still another object of the present invention is to provide an optical film with a surface structure, capable of preventing a lower surface of a upper layer material from being scratched to be helpful for elevate a yield factor of an electronic product encapsulating a prism sheet, a upper layer material and etc.

### BRIEF DESCRIPTION OF THE DRAWINGS

The present invention can be more fully understood by reference to the following description and accompanying drawings, in which:

FIG. 1 is a schematic view of a conventional back light system of a display;

FIG. 2 is a schematic view of a conventional prism sheet;

FIG. 3 is a schematic view of various light refraction modes of a conventional prism sheet;

FIG. 4 is a schematic view, showing a conventional prism sheet and a upper layer material supported thereby;

FIG. 5 is a cross sectional view, showing an optical film of a first preferred embodiment according to the present invention;

FIG. 6 is a schematic view, showing an optical film and a upper layer material supported thereby of the first embodiment according to the present invention; and

FIG. 7 is a cross sectional view, showing an optical film of a second preferred embodiment according to the present invention.

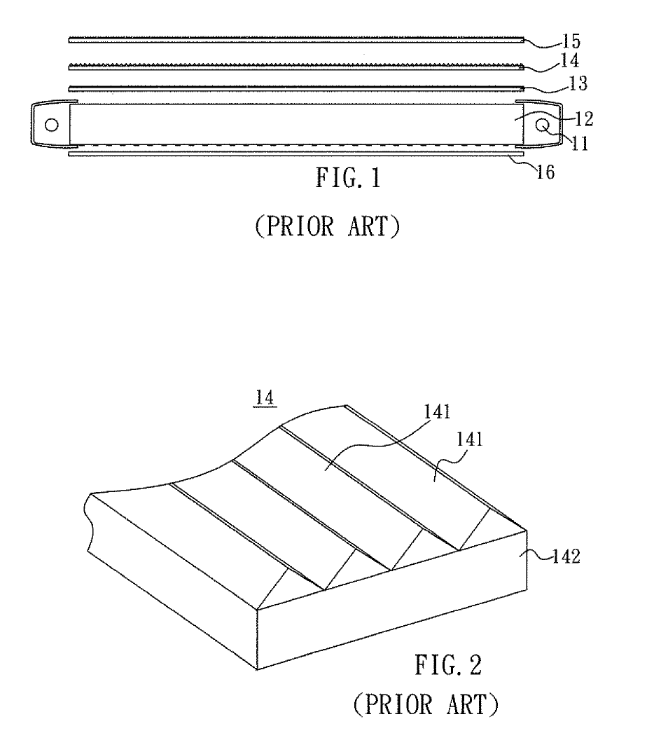

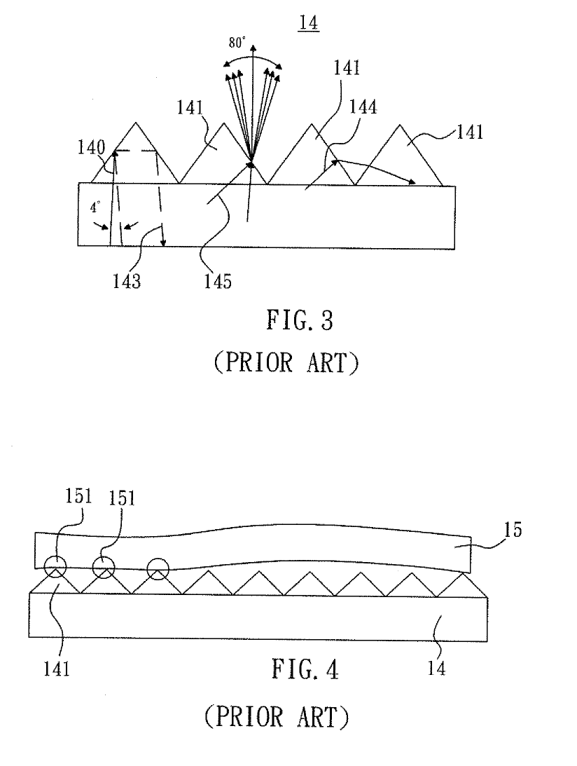

### DETAILED DESCRIPTION OF THE PREFERRED EMBODIMENTS

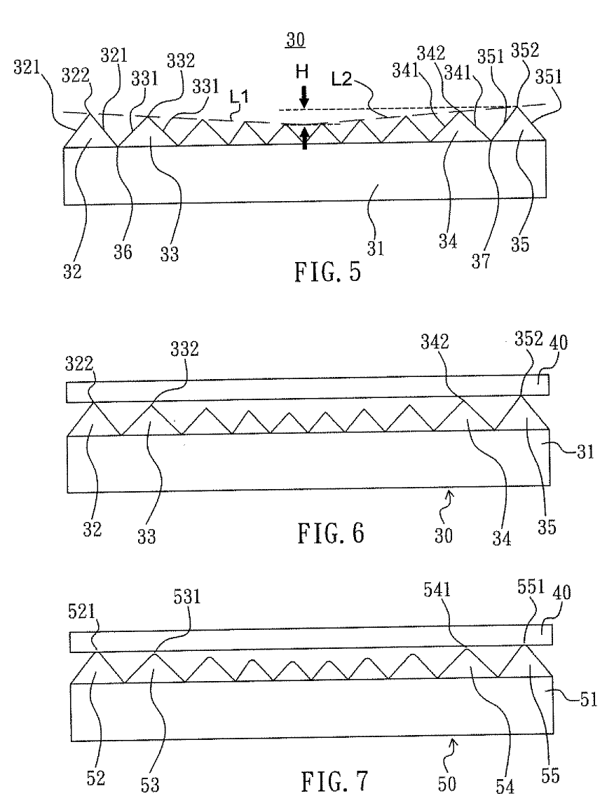

Please refer to FIG. 5. An optical film with a surface structure of the present invention is used for alleviating adhesion of the optical film to a upper layer material while being used for supporting the upper layer material. An optical film 30 with a surface structure of a first preferred embodiment according to the present invention comprises a substrate 31 used for allowing light to pass through. One surface of the substrate 31 comprises a plurality of light controlling elements 32, 33, 34 and 35 with their longitudinal axes arranged almost parallel to each other; the plurality of light control elements 32, 33, 34, 35 are respectively provided with two inclined faces 321, 331, 341, 351 to form an independent peak 322, 332, 342, 352; the two adjacent inclined faces 321, 331, 341, 351 between each two independent peaks 322, 332, 342, 352 are connected to form an independent valleys 36, 37; a peak vertex angle of each independent peak 322, 332, 342, 352 is the same as a valley included angle of each independent valley 36, 37; the independent valleys 36, 37 are at the same plane.

The optical film 30 of the present embodiment is characterized in that heights of the independent peaks 322, 332, 342, 352 are varied from high to low and then from low to high periodically. Virtual connecting lines L1, L2 of summits of the independent peaks 322, 332, 342, 352 varied from high to low and low to high respectively are a line, and a spacing interval between the two adjacent independent valleys 36, 37 is varied in geometrical proportion with heights of the independent valleys 322, 332, 342, 352.

Please refer to FIGS. 5 and 6. The heights of the independent peaks 322, 332, 342, 352 of the light control elements 32, 33, 34, 35 are periodically varied, a upper layer material 40 can only be brought into contact with few higher independent peaks 322, 332, 342, 352 such that the number of the independent peaks 322, 332, 342, 352 brought into contact with the upper layer material 40 can be decreased effectively to alleviate adhesion generated between the optical film 30 and the upper layer material 40 and reduce a adhesion area, white spots generated while being observed at a large angle of view and scratches generated from a contact of the peaks of the independent peaks 322, 332, 342, 352 with the upper layer material so as to be helpful for elevating a production yield factor of electronic products encapsulating the optical film 30, the upper layer material 40 and etc.

The heights of the independent peaks 322, 332, 342, 352 of the control elements 32, 33, 34, 35 of the optical film 30 of the present invention are periodically varied, the virtual connecting lines L1, L2 of the summits of the independent peaks 322, 332, 342, 352 varied from high to low and low to high respectively are a straight line to allow the light control elements 32, 33, 34, 35 to be manufactured more easily. Furthermore, when a period of the height variation of the independent peaks 322, 332, 342, 352 is shorter, light emitted from the optical film 30 rather shows no observable line generated from the height periodically varied independent peaks 322, 332, 342, 352 while being observed at two sides of the optical film 30.

The height different H of each independent peak 322, 332, 342, 352 of the optical film 30 of the present embodiment is not larger than 5˜10 um (micrometer); the ratio of the largest and the smallest among the heights of the independent peaks 322, 332, 342, 352 is not larger than 1.2˜1.05. A height variation period is between two to ten independent peaks every time. An included angle range of a vertex angle of each independent peaks 322, 332, 342, 352 is between 70 degrees and 110 degrees. A height variation period of the independent peaks 322, 332, 342, 352 is less than 200 um (micrometer).

Please refer to FIG. 7. A structure of an optical film 50 with a surface structure of a second preferred embodiment according to the present invention is almost the same as the optical film 30 of the first embodiment and comprises a substrate 51 for allowing light to be passed through. One surface of the substrate 51 comprises a plurality of light control elements 52, 53, 54, 55 with their longitudinal axes arranged approximately parallel to each other; the plurality of light control elements 52, 53, 54, 55 are respectively provided with an independent peak 521, 531, 541, 551 but a vertex angle of each independent peak 521, 531, 541, 551 is an arc angle; the second embodiment can also achieve the same effect as the first embodiment. Furthermore, arc vertex angles of the independent peaks 521, 531, 541, 551 will not scratch a upper layer material even more.

The present invention allows an optical film to have an innovative supporting structure to be manufactured more easily, the adhesion generated when the optical film supports a upper layer material at a lower surface thereof to be alleviated, a adhesion area between a prism sheet and the upper layer material and white spots generated while being observed at a large angle of view to be reduced and scratches generated on independent peaks of the optical film and the upper layer material to be decreased to be helpful for increasing a production yield factor of electronic products encapsulating the optical film, the upper layer material and etc. Furthermore, a vertex angle of the independent peak is arc such that the scratches generated on the independent peaks and the upper layer material can be decreased even more.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical film with a surface structure, used for alleviating adhesion generated between said optical film and a upper layer material, including a substrate with one surface thereof comprising a plurality of light control elements with longitudinal axes thereof arranged approximately parallel to each other; each said light control element including two inclined faces and an independent peak formed thereby; said two adjacent inclined faces between each said two independent peaks being connected to each other to form an independent valley; heights of said independent peaks being periodically varied from high to low and then from low to high; virtual connecting lines of summits of said independent peaks varied from high to low and from low to high respectively being a straight line; an spacing interval between said independent valleys being varied in a geometric proportion with height variations of said independent peaks.

2. The optical film with a surface structure according to claim 1, wherein vertex angles of said independent peaks are the same.

3. The optical film with a surface structure according to claim 2, wherein valley included angles of said independent valleys are the same.

4. The optical film with a surface structure according to claim 3, wherein a spacing interval between said two adjacent independent valleys is varied in a geometric proportion with height variations of said independent peaks.

5. The optical film with a surface structure according to claim 4, wherein a height difference of each said independent peak is not larger than 5˜1 um.

6. The optical film with a surface structure according to claim 4, wherein a ratio of the largest and the smallest heights of each said independent peak is not is not larger than 1.2˜1.05.

7. The optical film with a surface structure according to claim 4, wherein a height variation period of said independent peaks is between two to ten independent peaks every time.

8. The optical film with a surface structure according to claim 4, wherein a height variation period of said independent peaks is less then 200 um.

9. The optical film with a surface structure according to claim 4, wherein an included angle range of vertex angle of each said independent peak is between 70 degrees and 110 degrees.

10. The optical film with a surface structure according to claim 4, wherein said independent valleys are at the same plane.

11. The optical film with a surface structure according to claim 1, wherein said vertex angles of said peaks are an arc angle.

12. The optical film with a surface structure according to claim 2, wherein said vertex angles of said peaks are an arc angle.

13. The optical film with a surface structure according to claim 3, wherein said vertex angles of said peaks are an arc angle.

14. The optical film with a surface structure according to claim 4, wherein said vertex angles of said peaks are an arc angle.

15. The optical film with a surface structure according to claim 5, wherein said vertex angles of said peaks are an arc angle.

16. The optical film with a surface structure according to claim 6, wherein said vertex angles of said peaks are an arc angle.

17. The optical film with a surface structure according to claim 7, wherein said vertex angles of said peaks are an arc angle.

18. The optical film with a surface structure according to claim 8, wherein said vertex angles of said peaks are an arc angle.

19. The optical film with a surface structure according to claim 9, wherein said vertex angles of said peaks are an arc angle.

20. The optical film with a surface structure according to claim 10, wherein said vertex angles of said peaks are an arc angle.
